(19) United States
(12) Patent Application Publication
(10) Pub. No.: US 2003/0081735 A1
(43) Pub. Date: May 1, 2003

(54) System and method for detecting and reporting defective telephone lines and alarm events

(76) Inventors: Thomas M. Emory JR., Willow Grove, PA (US); Tomas J. Murray, Villa Rice, GA (US); Ray F. Bridenbaugh, JR., Marietta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/228,726

(22) Filed: Aug. 27, 2002

Related U.S. Application Data
(60) Provisional application No. 60/315,280, filed on Aug. 27, 2001.

(51) Int. Cl. H04M 1/24

(52) U.S. Cl. 379/1.01; 340/661

(57) ABSTRACT

Optically isolated input circuits and a processor interface with either a switch closure event detector or a pulse generator to rapidly detect changes in the status of inputs representing events such as telephone line cuts and emergency conditions. The processor determines telephone line status by applying software algorithms to data acquired with a voltage sampling circuit. The processor initializes a radio module to wirelessly transmit information regarding detected events over a local wireless system to an event clearinghouse.

### RELATED APPLICATION

This application claims priority to U.S. Provisional Patent Application No. 60/315,280 entitled, System and Method for Detecting and Reporting Defective Telephone Lines and Alarm Events, the entirety of which is incorporated by reference.

### FIELD OF THE INVENTION

The present invention relates in general to monitoring systems and telecommunications, and more particularly to detecting and reporting defective telephone lines and alarm events.

### BACKGROUND OF THE INVENTION

Alarm systems that report events, burglaries, fire, smoke, and similar events to central stations are well known in the alarm industry. These central stations analyze an event and call to request appropriate support from fire companies or police departments. Most alarm systems include an alarm panel with indicators that warn the occupants of a facility of an emergency condition. To relay the warning to the authorities or to a central station, however, alarm panels must interface with a separate communications device. Many alarm systems interface with a standard telephone to transmit messages over a public switched telephone network (PSTN) to the central station. However, standard phone lines may be unreliable, particularly in certain situations, such as burglaries, fires, major calamities, and other conditions when standard phone lines typically experience unavailability.

The alarm industry has developed methods of using wireless communication technology to supplement (or “backup”) alarm panel systems. Generally, a wireless backup device consists of a data interface to a standard cellular telephone. Messages can be routed over a voice channel via the cellular telephone if the primary telephone line is not functional. More specifically, if the alarm system cannot access landline telephone service, then the alarm system places a wireless telephone call using the backup device. The backup device communicates with a mobile switching center (MSC), which authenticates the backup device and routes the call to a monitoring center.

Typical wireless backup approaches have several disadvantages. According to many such approaches, an alarm first attempts to transmit data over a landline connection. After detecting the failure of these attempts, a wireless backup device determines that the landline is unavailable or disrupted, and transmits the data wirelessly. Other than attempting to use the landline, the backup device has no means of determining that the landline has been disabled. Thus, an alarm system that uses such a backup system may experience a significant delay while the PSTN call is attempted, before reporting the disabled landline and any other event. Moreover, the alarm system only detects a loss of line integrity when the alarm system attempts to report another detected event. Some alarm systems attempt to address this shortcoming by periodically attempting a PSTN call to test the landline. However, this solution is imperfect due to the unnecessary disruption of the user's ability to access the telephone line during these tests. The test calls can also cause computer modems to lose carriers. Other alarm systems periodically check the telephone line for dial tone, but cannot detect loss of dial tone that occurs between scheduled checks.

Wireless event reporting devices can be more expensive than wireline counterparts due at least in part to cost of the standard cellular telephone and service fees for access to cellular voice channels. Moreover, cellular voice channels are often unavailable or unreliable in certain situations, such as during inclement weather or periods of heavy congestion. In view of the emergency situations that typically cause the alarm conditions, delays and disruptions in communicating alarm and event data can be costly.

Wireless event reporting devices are typically installed by making electrical connections between a telephone line and monitoring device, and between the monitoring device and a power source. Separate connections must also be made to connect the monitoring device to a radio or a cellular telephone, which relays the reporting data to a central station. Thus, the customer either directly or indirectly bears the cost of installation, which is usually performed by an electrician or other professional.

Thus, there is a need for a reliable, responsive, and cost-efficient system and method for detecting disruptions in telephone service and communicating data regarding the attendant circumstances.

### SUMMARY OF THE INVENTION

The present invention fulfils the needs described above by providing systems and methods for detecting and reporting telephone line status and alarm events using a compact, relatively inexpensive and reliable transport mechanism. Generally, systems and methods of the present invention implement processor-based logic that detects loss of landline integrity, rather than relying on an automatic dialer to detect loss of dial tone. To report loss of telephone line integrity, the invention utilizes wireless transport mechanisms to transport data and status signals independent of landlines. One aspect of the invention is the combination of processor-based logic and wireless transport systems and methods, which reduce installation costs, while increasing the responsiveness and reliability of the entire system. Another aspect of the invention is the various wireless transport mechanisms which improve the cost-effectiveness and further increase the reliability of the systems and methods of the invention.

More specifically, the present invention provides an integrated alarm system (IAS) that includes low cost, optically isolated input circuits in conjunction with a processor that determines the status of the telephone lines and input events. The processor executes code which relays information regarding line integrity events detected by a telephone event detector circuit (TED), and external events detected by an external event detector circuit (EED), while preventing false trigger events. Line integrity events include telephone disruptions, and external events include intrusion, fire, noxious fumes, radiation, and other emergency conditions. To report the status of the detector circuits, the IAS includes a preferably integral transceiver that implements one or more transport mechanisms to wirelessly transmits event data to an event clearinghouse.

The event clearinghouse can forward the event data to any other appropriate recipient. In certain embodiments, the event data is relayed from the event clearinghouse to a secure web site. Access to the secure web site can be controlled by authentication protocols such as passwords, encryption keys, and the like.

In other embodiments, event data is forwarded directly to a control center or a network administrator for appropriate action. For instance, a network administrator can re-route communications from a system that is associated with a disabled landline to a system that is associated with an intact land line.

One of the various transport mechanisms of the invention has the advantage of transmitting data over a control channel, rather than occupying a cellular voice channel. In this embodiment, the transport mechanism mimics an autonomous registration message. Event data is encoded into an electronic serial number (ESN) field and transmitted over a cellular control channel via a transceiver. The transceiver transmits the event data through a cellular control network to a gateway controlled by the monitoring entity. Once received at the gateway, the monitoring entity translates the ESN field and processes the event data.

An aspect of the invention is that, unlike typical alarm systems, the IAS does not necessarily interface with a separate communications device. Rather, the components of the IAS are preferably integrated into a single, portable, and compact housing that monitors the telephone line integrity and transmits messages independent of any other device.

The IAS monitors telephone line integrity using a processor that determines that the voltage or current on a monitored telephone line has dropped below a predetermined threshold, preferably for more than a predetermined amount of time. When such a drop is experienced, the processor activates an enable circuit that allows a charging capacitor to discharge. While the charging capacitor discharges, the voltage on a current sensor connected between the charging capacitor and the telephone line is low. When the charging capacitor has discharged, or after a predetermined period of time, if the voltage on the telephone line is not higher than the threshold, the processor declares a loss of line integrity, formats a message to that effect, and causes the transceiver to send the message to an event clearinghouse. The event clearinghouse can forward the message to an event recipient, which has been previously identified when the IAS was registered.

The IAS can be easily installed in as few as two steps, the order of which is not necessarily critical. First, for each telephone line to be monitored, the user plugs a communications cable from the IAS into a telephone line interfaces, such as typical household telephone outlet, using a standard “pass-through” connector, such as an RJ-45 telephone jack. The pass-through connector allows the IAS to monitor the PSTN line without causing any degradation or impact to the communications carried on the line. The user also plugs a power cord from the IAS into a typical household power outlet. The entire IAS can be housed in a relatively small enclosure that can be mounted on a wall by a mounting means such as an integral bracket and screws, suction cups, or adhesives.

The IAS is also easily activated by a user. To activate the IAS, the user can power the unit on, by plugging in the power cord and/or toggling a power switch to an “on” position. The user then may establish settings that control or affect the operation of the IAS. The user settings can be established using the functional equivalent of one or more switches or other input devices. For example, a three-position dipswitch can allow the user to specifically choose either a carrier A, carrier B, or “autoselect,” to establish the protocol the IAS uses to search for an available carrier for outgoing messages. As another example, the IAS may include another dipswitch that allows the user to indicate the type of contact closure that the IAS will monitor via the external event detector circuit. Any user setting or other user input, such as to arm and disarm the IAS, can be implemented using other type of control, such as a keypad, mouse, trackball, touchscreen, toggle switch, or joystick.

The IAS can also include a user interface that enables the user to register service for the IAS, provide contact information, and to establish a preferred event handling procedure. The user interface can be a web page. The event handling procedure details how particular events are reported by the event clearinghouse. For instance, if an event consists of the opening of a contact closure on an interior door, the user may direct the event clearinghouse to call the user at work, to post the event on a user-accessible web page, or to email the user. However, if the event consists of a contact closure generated by a smoke detector, the user may want the event clearinghouse to immediately contact the appropriate fire department.

These and other objects, features, and/or advantages may accrue from various aspects of embodiments of the present invention, as described in more detail below.

### BRIEF DESCRIPTION OF THE DRAWINGS

FIG. 1 is functional diagram of an exemplary environment according various embodiments of a system and method for monitoring and reporting defective telephone lines and alarm events;

FIG. 2 is a block diagram of the components of an IAS according to various embodiments of the invention; and

FIG. 3 is a circuit schematic of an exemplary monitoring circuit according to certain embodiments of the invention.

### DETAILED DESCRIPTION OF THE INVENTION

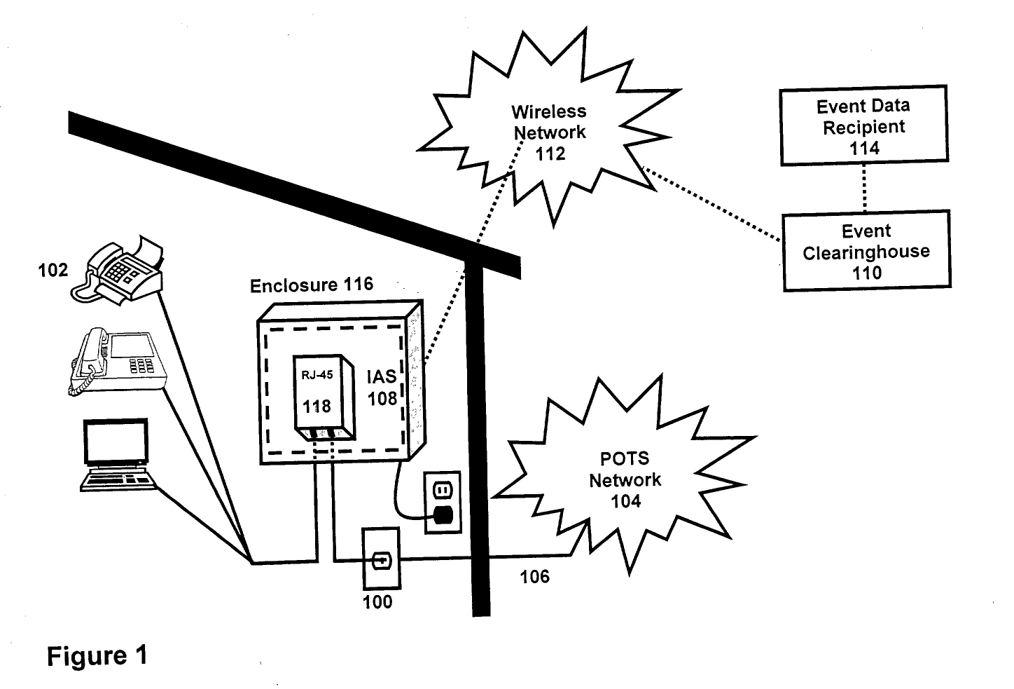

Particular embodiments of the present invention will now be described in greater detail with reference to the drawings. FIG. 1 is a functional diagram of an exemplary environment according to certain embodiments of the present invention. Certain embodiments of the systems and methods of the invention are implemented to monitor conditions at a residential or commercial facility. The facility includes a landline interface 100, which connects to one or more communications devices 102, such as telephones, facsimile machines, computer modems, and autodialers to a telephone network 104 via a telephone line 106 (the “landline”).

According to various embodiments of the invention, an IAS 108 monitors and reports the integrity of the landline 106 and the occurrence of various other events. The IAS 108 reports to an event clearinghouse 110 via a wireless network 112. The event clearinghouse can forward event data to any authorized event data recipient 114.

IAS Components

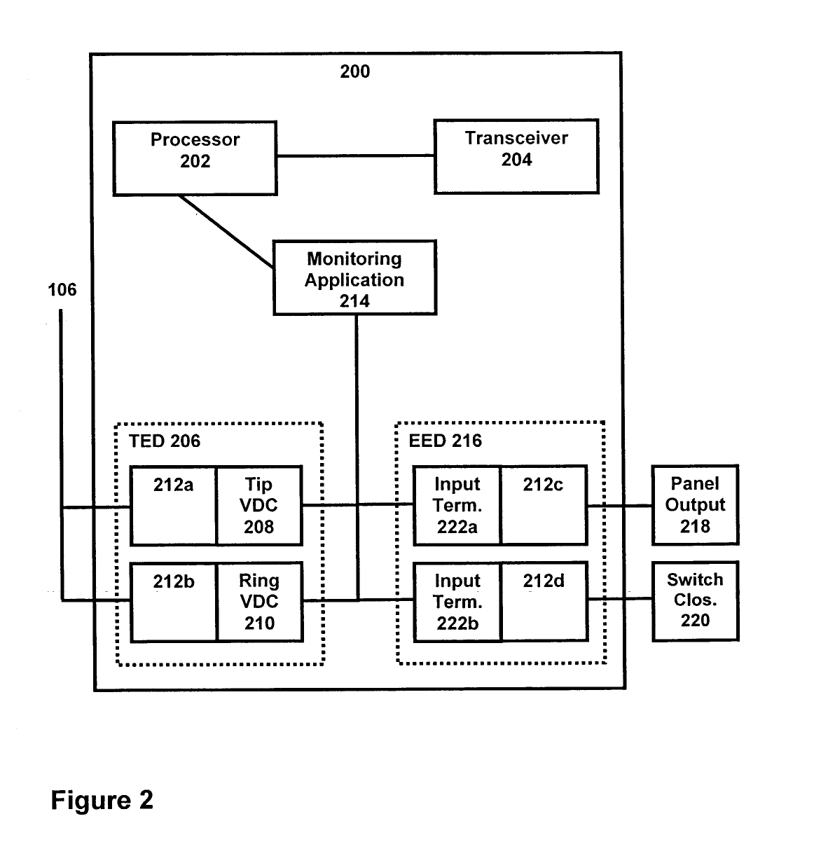

FIG. 2 is a block diagram showing the components of an IAS according to various embodiments of the invention. The IAS 108 monitors the landline using a monitoring circuit 200. The monitoring circuit includes a processor 202, which is preferably housed on a single semiconductor chip. The processor 202 controls a transceiver 204, including initialization and data transport error control.

According to certain embodiments of the invention, the monitoring circuit 200 monitors two sets of components. The first set of components is a telephone event detector (TED) 206. The TED detects disruptions in telephone service, such as cut lines. For each telephone line monitored by the IAS, the TED includes two preferably identical detection circuits that detect the presence of a signal (preferably, voltage or current) on the tip and ring lines, respectively. For example, a tip voltage detection circuit (VDC) 208 measures the voltage on the tip line of the telephone line. A ring voltage detection circuit 210 measures the voltage on the ring line of the telephone line. Both VDCs are preferably high impedance. The TED circuitry is also preferably isolated from the phone lines via optoisolators 212a, 212b. A bridge input can used to make each voltage detection circuit 208, 210 insensitive to polarity of the connections to the telephone line. The processor controls a monitoring application 214 (implemented as software or firmware) that processes a signal that is based upon the voltage differential between each voltage detection circuit 208, 210. The monitoring application analyzes the nature of the detected signal to determine whether the telephone line is functional. For instance, the monitoring application 214 compares the signal to pre-programmed values indicative of telephone line events. In one embodiment, the signal can be either “0” or “1,” with “1” indicating that the telephone line 106 is intact.

An external display device (not shown), such as one or more LEDs, a digital and alphanumeric readout, or a graphical user interface (GUI) is included in certain embodiments of the IAS 108 to indicate the status of the monitored telephone lines.

The second set of components monitored by the monitoring circuit is an optional external event detector (EED) 216. The EED 216 detects external events by receiving input data from alarm panel outputs 218, and/or switch closures 220. Alarm panel outputs interface with sirens, bell drivers, switch closures. For instance, a panic button can be installed on the exterior of the alarm panel, which the user can press to cause the IAS to report an event. Switch closures can be associated with perimeter alarms or counters. A human operator can also drive alarm panel outputs via an input device associated with the alarm panel, such as a switch, keyboard, joystick, keypad, mouse, trackball, touchscreen, or voice, pressure, or light activated controls.

External event data is relayed to the EED 216 via EED input terminals 222, which are preferably isolated using optoisolators 212c, 212d. Each optoisolator 212c, 212d protects the circuitry of the event detector from external surges and other transients. The output of each optoisolator 212c, 212d is detected by the EED 216 and a corresponding state is relayed from the EED 216 to the processor 202. For instance, the EED 216 may include an inverter (not shown) that translates the output of each optoisolator 212c, 212d into processor interrupts. Software or firmware in the IAS 208, preferably the monitoring application 214, determines the nature of the external event, based on external event settings established by the user during the user setup procedure, which is described in more detail below.

The transceiver 204 incorporated in the monitoring circuit 200 provides a wireless link to the event clearinghouse 110 in the event of impairment of telephone service or an external event. Referring again to FIG. 1, the event clearinghouse 110 may forward event data to an event data recipient 114, such as a physical facility or an individual that monitors the premises of multiple customers, or to a web site or user interface that can be accessed by a customer or monitoring entity.

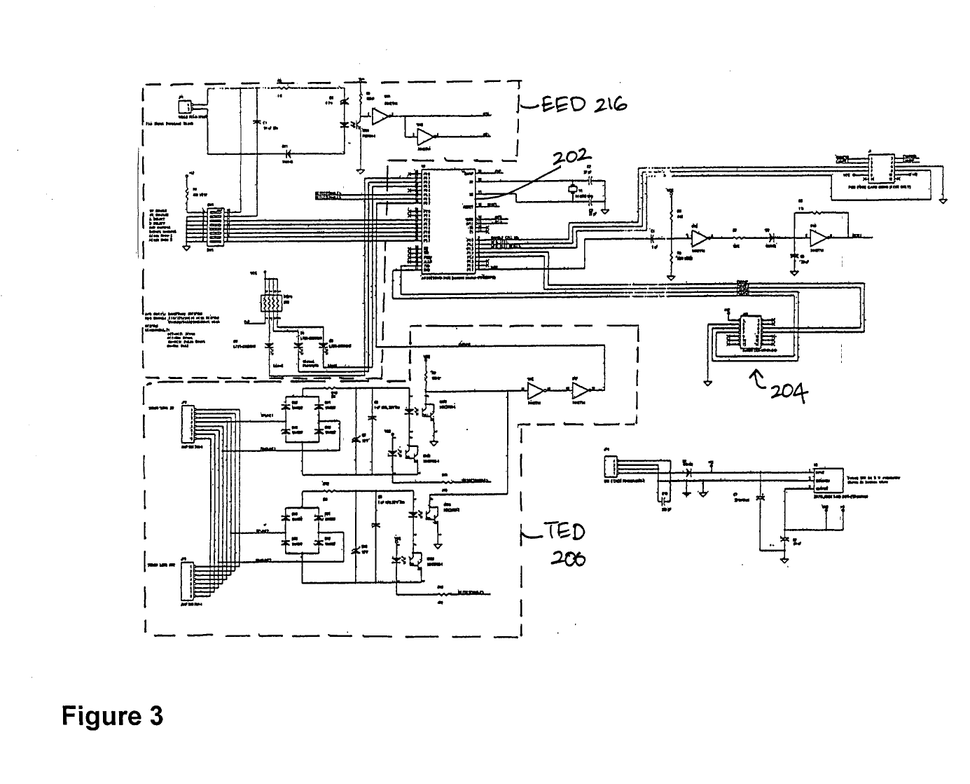

An exemplary implementation of a monitoring circuit according to certain embodiments of the invention is shown in FIG. 3. As shown, the processor is an Intel 8051 microprocessor.

Installation

As shown in FIG. 1, the entire IAS 108, including the monitoring circuit 200 and associated components can be housed in an enclosure 116, such as a small plastic case. The enclosure 116 is constructed such that a user can install the IAS 108 without the services of a professional. The user preferably mounts the IAS 108 on a wall using one or more attaching members (not shown), such as mounting screws or double-sided adhesive strips. The customer then plugs a power cord to a power supply, such as a standard power outlet.

To monitor one or more landlines 106, the user also connects a communications cable, such as a standard UL-listed telephone line cord, from the IAS to the telephone interface 100 for each monitored telephone line. As shown in FIG. 1, the landline connection is preferably made using pass-through connector 118, such as an RJ-45 telephone jack having an input (“line”) side and an output (“phone”) side. The phone side of the pass-through connector 118 is connected to at least one telephone or other communications device 102, and the line side of the pass-through connector is connected to the landline 106 coming from the telephone network. The pass-through connector 118 enables the IAS 108 to operate as a “head-end” device that reliably detects voltage, current, or other telephone line signals without degrading or otherwise impacting the signals on the landline 106.

To monitor some external events, the user can connect the IAS to one or more switches, signal generators, pulse counters, or alarm inputs to an EED terminal preferably on the exterior of the IAS enclosure. A suitable connector, such as a push or screw terminal connector, secures an external event cable to the IAS circuitry. The external event cable can be any suitable signal carrying cable, such as an insulated 18-gauge multi-stranded wire. Other external events are generated by user inputs, such as the panic button described above, which can be entered without the need for any external connections.

Setup

After installing the IAS, the user also performs a basic user setup procedure. Elements of the user setup procedure can involve manually setting switches or utilizing an input device located preferably on the exterior of the IAS enclosure, and/or utilizing a user interface that is located on a web page.

The user can program the IAS to recognizes the nature of detected events. In certain embodiments, the user uses switches to program the IAS, while in other embodiments, the user uses an input device, such as a keyboard, mouse, touchscreen, or trackball. This ability to program the IAS is particularly applicable to certain embodiments in which the monitoring circuit includes the EED. If the EED input terminals monitors switch closures, pulse counts, or alarm panel outputs that are external to the EED, the user must describe to the IAS the type of event that is indicated by a signal received via the input terminals. As another example, the user can program the IAS to ignore each telephone disruption with a duration that is less than a user-provided value, or to repeatedly report a disruption that continues for an extended period of time. As yet another example, the user can program the IAS to select a specific carrier or carriers to use for reporting events. According to this example, the IAS includes a three-position dipswitch that allows the installer to select either “A” carrier, “B” carrier or “Auto-Select.” If “Auto-Select” is selected, the IAS will search for the “B” carrier prior to the “A” Carrier. If the dipswitch is set to a specific carrier (either “A” or “B”), and that carrier fails or drops a communication, then the IAS will automatically seek access to the wireless network from the alternate carrier. Alternatively, any or all of the user setup procedure can be accomplished using web based user interface.

According to the embodiments of the invention that employ a secure monitoring web site, the user initiates monitoring service by accessing the secure site and establishing an online account. The user is prompted for identifying information that identifies the user and the IAS used by the user. The user establishes a contact list that includes the names, telephone numbers, email addresses other contact information for various individuals and entities associated with the user. The user can also be prompted for credit or other financial information (bank routing numbers, etc.). After supplying this information, the user interacts with the user interface on the secure site to establish monitoring service preferences. Monitoring service preferences include event-handling procedures. For example, in response to a given event, the event clearinghouse can notify user contacts, control centers, network administrators and other interested parties.

Other internal setup processes are performed by the processor. When the IAS is powered up, and at various other times, the processor identifies all accessible communications systems. When the processor is powered up, the processor commands the transceiver to access the optimal accessible communications system. As an example, assume carriers “A” and “B” are accessible. If carrier “A” exhibits greater signal strength than carrier “B,” then the processor directs the transceiver to select carrier “A” for further operations and communications.

Telephone Event Monitoring

The circuit components of the TED include a charging capacitor, an enable circuit, and a current sensor. The enable circuit and the current sensor include any appropriate circuit elements, such as optoisolation darlington transistors. According to one aspect of the invention, the monitoring circuit continuously samples each monitored PSTN line, using the current sensor as a sampling switch. Using the current sensor, the processor samples a signal that indicates whether the voltage between a tip voltage detection circuit and a ring voltage detection circuit is above a predetermined level. For example, if the voltage between the tip voltage detection circuit and the ring voltage detection circuit is above a threshold voltage, the signal supplied by the processor will be a “1,” and the telephone line integrity is confirmed. However, if the voltage is in a range that is below the predetermined threshold voltage, the signal supplied to the processor will be a “0.” processor initializes a timer. The timer preferably implements a short delay, such as 30 seconds, to ensure that low voltage condition is more than a routine telephone line transient. If the low voltage condition persists after the delay has run, the processor activates the enable circuit. The threshold voltage is preferably preprogrammed into the IAS, and is based upon the minimum voltage required to carry a call over the telephone line. In an exemplary embodiment, the threshold voltage is 2.5 volts.

The monitoring circuit may also include a signal conditioner, such as a bridge circuit, which interfaces with the tip and ring lines of the telephone system, the TED, and the processor. The signal conditioner limits the output voltage to protect the TED, and allows for interchangeability of the tip and ring lines.

Upon activation, the enable circuit initiates a sequence that causes either a pulse to be generated to confirm the integrity of the telephone line, or a line fault to be declared. Activation of the enable circuit allows current stored in the charging capacitor, which continuously trickle charge prior to activation of the enable circuit, to flow into the current sensor. The current flowing into the current sensor causes the voltage at the output of the current sensor to go low. The processor continues to monitor the output of the current sensor. When the current in the charging capacitor is depleted, the voltage at the output of the current sensor should go high if there is voltage on the telephone line, thereby generating the line integrity pulse. If the line integrity pulse is generated and detected by the processor, the integrity of the telephone line is confirmed. If the processor does not detect a line integrity pulse after a predetermined time has elapsed (the “discharge delay”), the processor generates a message indicating loss of line integrity. The discharge delay, which is preferably sufficient time required for the charging capacitor to discharge, is measured by the timer in the processor.

The processor can delay activating the enable circuit for a short period of time (the “enable delay”). For instance, the monitoring circuit implements an enable delay of 30 seconds after determining that the voltage between the tip and ring lines is below the threshold voltage, during which the processor waits before activating the enable circuit. The enable delay, particularly in combination with the discharge delay, prevents false reports of loss of line integrity that are caused by sporadic telephone line transients, or other brief disruptions in telephone line integrity.

External Event Monitoring

The IAS can optionally have at least one input that detects an external event, such as a switch closure or the presence of an input voltage. A switch closure typically occurs when an external switch is energized, such as when a monitored door or window is opened. An input voltage can also be applied in response to an audible alarm, or by pressing a button on the alarm panel to summon the police or fire department. Any of these events is detected by the external event detector (EED), which then generates a processor interrupt. The IAS includes software or firmware that formats each interrupt so as to enable the processor to distinguish between a siren or a bell, and between a burglar alarm and a fire alarm. In addition, the IAS can be programmed to count input pulses and to report total accumulated counts.

Message Generation

When the processor declares that a telephone line event or external event has occurred, the processor formats a message to be sent by the processor to the clearinghouse, via the wireless transceiver. External events can be reported independently of telephone line events and vice versa. In other words, a telephone line event will be reported regardless of whether an external event has been detected, and an external line event will be reported regardless of whether a telephone event has been detected. A predefined protocol specification defines the composition of each message.

Each message and other communication transmitted by the IAS includes a unique device identifier that identifies the IAS. In one embodiment, the device identifier is a 24-bit data field that is formatted as a mobile identification number (MIN). A MIN typically identifies the telephone number assigned to a cellular phone, and is used to route telephone calls to the cellular telephone. However, in one embodiment, the MIN is used by the IAS to properly direct the transmission and receipt of data to and from the event clearinghouse. A cellular service provider (CSP) reserves a block of MINs for IAS devices, so that when a communication is received from an IAS, its MIN causes the CSP to forward the communication to the event clearinghouse.

Each message or other communication may also include an event descriptor that identifies an event that is being reported by the IAS. The device identifier and the event descriptor may be separate data fields, or may be combined in a single data field. In one embodiment of the present invention, the event descriptor is a 32-bit data field that is formatted as an electronic serial number (ESN). The ESN typically is a hard-coded field that uniquely identifies a cellular telephone, and includes a manufacturer code, a reserved area, and a serial number assigned by the manufacturer of the cellular telephone. In this embodiment, however, the processor redefines the event descriptor each time the processor reports an event, according to a predefined bit definition. In an exemplary embodiment, the processor uses the following bit definition:

| Bit | 31 | 30 | 29 | 28 | 27 | 26 | 25 | 24 |
|---|---|---|---|---|---|---|---|---|
| Meaning | 0 | 0 | 0 | | | | | |
| Description | | | | Seq. # | | Tx Attempts | | |
| Bit | 23 | 22 | 21 | 20 | 19 | 18 | 17 | 16 |
| Meaning | | | | | | | | 0 |
| Description | RSL | | | | | | | ND or CMD |
| Bit | 15 | 14 | 13 | 12 | 11 | 10 | 09 | 08 |
| Meaning | | | | switch | fire | burglar | Line | Line 1 |
| | | | | | | | 2 cut | cut |
| Description | External Event | | | | | | | |
| Bit | 07 | 06 | 05 | 04 | 03 | 02 | 01 | 00 |
| Meaning | | | A | B | 2 way/ | 12/24 | 11-siren | 01-pulse mode |
| | | | | | 1 way | or day/wk | 10-switch | 00-bell |

| | |
|---|---|
| Description | User Settings |

According to this embodiment, bits 29-31 can be used to report a variety of conditions such as an acknowledgement, bits 24-28 report the status of the transceiver, including a reporting sequence number, and a transmission attempt counter. Bits 17-23 report an RSL. Bit 16 can be used to indicate a “no data” (ND) condition, or that the provision of the ESN is in response to a command (CMD) from a control center or the event clearinghouse. Bits 8-15 describe any telephone line or external event detected by the IAS. Bits 0-7 describe the user settings at the time of the transmission, as established by the user setup procedure. User settings can include the selection of carrier A or B (shown as bits 4 and 5), or the description of the type of external event input that is connected to the IAS (shown as bits 0 and 1).

Bit positions that are not used can be populated with a “0” to indicate a false condition.

According to the previous bit definition, bits 8 and 9 are used to indicate whether a landline has lost integrity. Accordingly, having determined that the voltages detected by a TED for landline “1 ” (line 1) indicate a line fault, this embodiment allows the processor to send only a 0 or a 1 to indicate that a landline is either cut or intact. Other embodiments may allot two or more bits for each landline monitored, so that more detailed status reports can be transmitted via the ESN. For example, if bits 8 and 9 are allocated for reporting the status of line 1, up to four different conditions can be reported, such as to describe the duration of a disruption.

Similarly, three or more additional bits can be allocated to report an external event detected by the EED, to allow more detailed reporting of events than can be afforded by using only bits 0 and 1.

In another embodiment, the event descriptor is a data field that is formatted as another type of alphanumeric message, such as an 128-bit SMS (short message service). The event descriptor can also be formatted for delivery over a standard voice channel.

Once the message is forwarded, the processor directs the transceiver to send the message to the event clearinghouse, via the wireless network.

Event Clearinghouse

The event clearinghouse receives messages from the IAS. After identifying the IAS, preferably using the device identifier, the event clearinghouse determines the appropriate event handling procedure. As described above, the customer preferably establishes event handling procedures via the secure web site. These event handling procedures determine whether the clearinghouse sends all messages to a single event recipient, or whether the clearinghouse interprets the encoded bit definition and routes the messages to different event recipients, depending upon the content of the event descriptor. Some default event handling procedures can be established without the input of the user. Alternatively, all event handling procedures can be controlled independently of the user, such as by a control center.

If the event handling procedure dictates that the message is to be routed to an individual, then the event clearinghouse can place a telephone call, or send an email or SMS message to the individual according to the contact list and priority established by the user during the user setup procedure. If the event handling procedure specifies the secure web site as the event recipient, the event data can be posted to the secure web site for retrieval, and preferably real-time monitoring by a the user or by a separate monitoring entity. Examples of monitoring entities include security companies, network control centers, and individual network administrators.

Remote Interaction

Although the transceiver has been described with respect to sending messages to the event recipient in response to a detected event, the transceiver can also receive data that enables acknowledgement of the receipt of messages, and testing and control of the IAS.

According to one embodiment, the bit definition allocates a bit for the IAS to request that the event recipient acknowledge receipt of a message reporting a telephone or external event, such as a cut line condition. As shown in the bit definition above, the acknowledgement can be implemented in any of bits 29-31. This acknowledgement informs the IAS that the message transmission has been successful. The acknowledgement can be forwarded to the user via a display on the IAS.

According to another embodiment, a control center or other entity external to the IAS pages, tests, or controls the IAS. To do so, the control center transmits a message or command to the IAS via the wireless network. The control center pages the IAS by sending a paging message through every tower on at least a portion of the wireless network. The paging message is designed to find the paged IAS, and includes a reference to the device identifier. When an IAS receives the paging message, the IAS compares the device identifier contained in the paging message with the device identifier assigned to the IAS (which is preferably stored in a memory element of the IAS). If the device identifiers match, then the IAS responds to the page. The IAS responds to the page by sending a message that is formatted to indicate that the IAS is responding to a page. For example, the IAS can send an ESN of type “PageVerify.” The paging message may also include a command that commands the IAS to respond in a particular manner. For instance, in addition to the device identifier, the paging message may include a code that corresponds to a particular command. As examples, commands can cause the IAS to provide a pulse count, to reset a counter or clock, to self-test, to shutdown, or to wakeup. The IAS can also be directed to provide an event report such as by checking the status of the monitored circuits upon receiving a “report alarms/external events” command, or by resending the last event message sent by the IAS.

As described above, certain embodiments use a MIN as the device identifier. In these embodiments, the desired command can be incorporated in the paging message using a secondary MIN. Thus, the combination of the primary and the secondary MINs direct the paging message to the corresponding IAS and control the response of the IAS to the command.

The foregoing description of various aspects of the invention has been presented only for the purpose of illustration and description and is not intended to be exhaustive or to limit the invention to the precise forms disclosed. Many modifications and variations are possible in light of the above teaching.

The various aspects of the embodiments of the invention involve at least the following features: (1) a system and method for interfacing with either siren or bell outputs of alarm panels to determine the nature of a signal and report changes in status of that signal; (2) a system and method for interfacing with either a switch closure event detector or a pulse generator to determine the nature of the input signal and reporting any change in status of the signal or an accumulated pulse count; (3) a system and method for interfacing with a standard voice line (PSTN) to determine a line cut event and reporting the line status independent of an alarm panel or system; (4) a system and method for initializing the transceiver to select the optimal wireless system; (5) systems and methods for determining telephone line status utilizing a voltage sampling circuit in combination with software algorithms to provide detection of an impaired phone line; (6) systems and methods for wirelessly transporting event data; and (7) systems and methods for routing event data according to event handling protocols.

Additions, deletions, substitutions, and/or modifications can be made to the systems and processes disclosed herein and the elements or embodiments thereof without departing from the spirit and scope of various principles, features, aspects, and advantages of the present invention.

What is claimed is:

1. An apparatus for detecting a loss of integrity of a telephone line having a tip line and a ring line and for transmitting an indication of the loss of integrity via a wireless network, comprising:
a telephone event detector for:
monitoring the tip line and the ring line; and
generating a telephone line output signal;
a processor for:
enabling the telephone event detector;
monitoring the telephone line output signal to detect the loss of integrity;
generating a message that includes the indication of the loss of integrity; and
sending the message to a wireless transceiver; and
the wireless transceiver for:
receiving the message; and
sending the message to an event clearinghouse via the wireless network.

2. The apparatus of claim 1, wherein monitoring the telephone line output signal to detect the loss of integrity, comprises:
monitoring a voltage differential between the tip line and the ring line via the telephone line output signal;
if the voltage differential is outside a predetermined range of voltage differentials, then enabling the telephone event detector circuit; and
monitoring the telephone line output signal to detect a pulse.

3. The apparatus of claim 2, further comprising:
if the pulse is detected, then determining that the telephone line is intact.

4. The apparatus of claim 2, further comprising:
if the pulse is not detected, then determining that the loss of integrity has occurred.

5. The apparatus of claim 1, wherein the telephone event detector is connected between a landline interface and a communications device.

6. The apparatus of claim 1, wherein the message is a 32-bit message.

7. The apparatus of claim 1, wherein the message is a 128-bit message.

8. The apparatus of claim 1, wherein the wireless transceiver sends the message via a voice channel of the cellular network.

9. The apparatus of claim 1, wherein the message includes a device identifier and an event descriptor that indicates the loss of integrity.

10. The apparatus of claim 7, wherein the device identifier is formatted as a mobile identification number (MIN).

11. The apparatus of claim 7, wherein the event descriptor is formatted as an electronic serial number (ESN).

12. The apparatus of claim 1, wherein the wireless transceiver sends the message to the event clearinghouse via a cellular network.

13. The apparatus of claim 12, wherein the wireless transceiver sends the message via a control channel of the cellular network.

14. The apparatus of claim 1, further comprising:
an external event detector circuit for:
monitoring an external event input; and
generating an event output signal to the processor.

15. The apparatus of claim 14, wherein the event output signal comprises an interrupt to the processor.

16. The apparatus of claim 1, wherein the event clearinghouse forwards the message to an event recipient, according to a predetermined event handling protocol.

17. The apparatus of claim 16, wherein the event recipient is a secure web site.

18. An apparatus for detecting a loss of integrity of a telephone line and for transmitting an indication of the loss of integrity via a wireless network, comprising:
a pair of current sensors for sensing a voltage differential between a tip line and a ring line of the telephone line and generating a telephone line output signal;
an enable circuit connected to the current sensor and a processor;
the processor for:
monitoring the voltage differential between the tip wire and the ring wire of the telephone line by monitoring the telephone line output signal;
if the voltage differential is outside a predetermined range of voltage differentials for more than a predetermined threshold period of time, then activating the enable circuit, so that the enable circuit causes a charging capacitor to discharge into the current sensors; and
monitoring the telephone line output signal to determine whether the telephone line has lost integrity; and
sending a message to a wireless transceiver; and
the wireless transceiver for:
receiving the message; and
sending the message to an event clearinghouse via a wireless network.

19. The apparatus of claim 18, further comprising:
an external event detection circuit for detecting an external event; and
generating an interrupt to the processor.

20. The apparatus of claim 18, further comprising:
a bridge circuit for limiting voltage provided to the current sensors and for supporting the interchangeability of the tip and ring lines.

21. The apparatus of claim 18, wherein monitoring the telephone line output signal to determine whether the telephone line has lost integrity, comprises:
monitoring the telephone line output signal to detect a pulse; and
if a pulse is not detected, determining that the telephone line has lost integrity.

22. A method for detecting and reporting a loss of integrity of a telephone line, comprising:
monitoring a voltage differential between a tip line and a ring line of the telephone line;
if the voltage differential is outside a predetermined range of voltage differentials, then activating an enable circuit;
monitoring an output of the enable circuit to determine whether the loss of integrity has occurred;
if the loss of integrity has occurred, then generating a message that indicates the loss of integrity; and
sending the message to an event clearinghouse via a wireless network.

23. The method of claim 22, wherein activating an enable circuit, comprises:
waiting a predetermined period of time to activate the enable circuit.

24. The method of claim 22, wherein monitoring an output of the enable circuit comprises:
monitoring the output of the enable circuit to determine whether a pulse is detected; and
if the pulse is detected, then determining that the loss of integrity has occurred.

25. The method of claim 22, wherein the wireless network is a cellular network.

26. The method of claim 25 wherein the message is sent via a control channel of the cellular network.

27. The method of claim 25 wherein the message is sent via a voice channel of the cellular network.

28. The method of claim 25 wherein the message is sent via a short message service (SMS).
